(19) United States
(12) Patent Application Publication
(10) Pub. No.: US 2019/0292416 A1
(43) Pub. Date: Sep. 26, 2019

(54) WEATHERING-RESISTANT ADHESIVE WITH GOOD WET-OUT CAPACITY, AND ADHESIVE TAPES BASED THEREON

(71) Applicant: tesa SE, Norderstedt (DE)

(72) Inventors: Martin Tassilo FENSKE, Hamburg (DE); Thilo DOLLASE, Hamburg (DE); Daniel SCHMITZ-STAPELA, Hamburg (DE)

(73) Assignee: tesa SE, Norderstedt (DE)

(21) Appl. No.: 16/361,731

(22) Filed: Mar. 22, 2019

(30) Foreign Application Priority Data
Mar. 23, 2018 (DE) 10 2018 204 463.5

(51) Int. Cl. C09J 7/38; C09J 7/24; C09J 5/00; C09J 11/08; C09J 11/06

(52) U.S. Cl. CPC C09J 7/387; C09J 7/243; C09J 5/00; C09J 11/08; B32B 7/06; C09J 2205/102; C09J 2205/106; C09J 2453/00; C09J 2423/106; C09J 11/06

(57) ABSTRACT

Disclosed is an adhesive composition comprising: (a) at least one kind of a saturated vinylaromatic block copolymer, (b) at least one kind of a first tackifier resin, which is a hydrocarbon resin having a DACP≥+25° C. and an MMAP≥+60° C., and also either (c1) at least one kind of a second tackifier resin, having a DACP≤0° C. and an MMAP≤+30° C., and (d1) at least one kind of an aliphatic or cycloaliphatic alkyl ester as a plasticizer, or (c2) at least one kind of a second tackifier resin, having a DACP≤0° C. and an MMAP≤+30° C., and (d2) at least one kind of an aliphatic or cycloaliphatic alkyl ester as a plasticizer, and also (e) optionally further additives. The adhesive composition combines high ageing stability with exceptional aptitude for bonding on porous and also on fibrous materials.

The present invention relates to an adhesive composition for permanent bonds with high weathering stability, to adhesive tapes based thereon, and to their use.

Styrene block copolymer-containing pressure-sensitive adhesives are known and are used for diverse purposes across a wide variety of self-adhesive tapes. The combination of polystyrene blocks and polydiene blocks results in mechanical and technical adhesive properties that are advantageous for numerous applications. For certain applications, however, enhanced ageing resistance is desired. For this purpose, styrene block copolymers whose polydiene block is hydrogenated and thereby saturated are frequently employed. Such formulations have relatively low peel adhesions, so making them particularly suitable for reversible pressure-sensitive adhesive applications, though also as hotmelts.

Known adhesives having a certain ageing stability are highly suitable for smooth substrates. Regularly a problem, however, is the adhesion to porous and/or fibrous substrates. The requirements imposed for this scenario, namely a certain flow of the adhesive into the porous substrate, cannot be adequately fulfilled by conventional weathering-resistant adhesives. This weakness is exacerbated if the adhesive is required not only to adhere well to a porous substrate but also not to exhibit any oozing. Oozing occurs if the adhesive is too elastic and therefore lacks dimensional stability, emerging from the roll at the sides in the case of a wound adhesive tape. Known practice is to add plasticizers to an adhesive for the purpose of adjusting the flowability.

U.S. Pat. No. 4,286,077 and also U.S. Pat. No. 6,455,627 disclose pressure-sensitive adhesive formulations based on hydrogenated styrene block copolymers, tackifier resins and, optionally, plasticizers.

DE 102007021504 A1 describes adhesive products based on hydrogenated styrene block copolymers. The products obtained exhibit reversible adhesion. Tackifier resins specified include, for example, hydrogenated hydrocarbon resins or derivatives of rosin. Furthermore, hydrocarbon-based plasticizers can be used.

US 2009/0324940 A1 discloses adhesives for surface protection films that are constructed from hydrogenated styrene block copolymers and resins. The adhesives can comprise resins based on stabilized rosin. The formulations in question are for reversible adhesives with a low peel adhesion (<3 N/cm).

Plasticizers known to the skilled person from the prior art for hydrogenated styrene block copolymer-based PSA (pressure-sensitive adhesive) formulations, therefore, include, in particular, oils (paraffinic or naphthenic) and liquid polyolefins or rubbers, or liquid hydrocarbon resins.

U.S. Pat. No. 7,109,263 teaches PSA formulations for redetachable labels that are based on styrene block copolymers—hydrogenated block copolymers may also be used here. A series of different plasticizers, primarily hydrocarbon-based, are cited, along with aromatic esters, alkyl adipates and alkyl citrates. Adhesives of this kind, however, are unsuitable for permanent bonds on porous or fibrous substrates.

DE 10 2007 044 322 A1 describes double-sided adhesive tapes with which extensive masking materials can be affixed for the surface protection, for example, of motor vehicles. For use on automotive paint, polyisobutylene-based adhesives are proposed; for fastening the extensive material, polyacrylate-based adhesives. There continues to be a need to provide bonding solutions which feature a higher bond strength on the extensive material, particularly when the extensive material is one based on polyolefins, and is therefore non-polar.

The object on which the present invention was based, therefore, was that of providing an adhesive composition which exhibits high long-term stability and which in particular is suitable for bonding on porous and/or fibrous materials, which may also be flexible and/or non-polar.

Surprisingly it has been found that an adhesive composition consisting of
(a) 25 wt % to 50 wt %, preferably 30 wt % to 40 wt %, of at least one kind of a saturated vinylaromatic block copolymer,
(b) 20 wt % to 50 wt %, preferably 25 wt % to 45 wt %, of at least one kind of a first tackifier resin, which is a hydrocarbon resin, having a DACP of more than +25° C. and an MMAP of more than +60° C.,
and also either
(c1) 0 wt % to 10 wt % of at least one kind of a second tackifier resin, having a DACP of less than 0° C. and an MMAP of less than +30° C., and
(d1) 5 wt % to 25 wt % of at least one kind of an aliphatic or cycloaliphatic alkyl ester as plasticizer,
or
(c2) 5 wt % to 25 wt %, preferably 10 wt % to 20 wt %, of at least one kind of a second tackifier resin, having a DACP of less than 0° C. and an MMAP of less than +30° C., and
(d2) 5 wt % to 15 wt % of at least one kind of an aliphatic or cycloaliphatic alkyl ester as plasticizer,
and also
(e) optionally further additives
   meets these requirements and allows flow into a porous and/or fibrous substrate so as to produce an effective bond, but at the same time exhibits sufficient cohesion, to prevent oozing, and good long-term stability. This “good long-term stability” refers in particular to the stability with respect to effects of temperature, light and oxidation.

“Consist of” or “consisting of” in the sense of the present invention means that a formulation or adhesive composition contains only the compounds recited and that beyond these there are no further ingredients present.

Preferred embodiments of the adhesive composition are found in the dependent claims.

### (a) Vinylaromatic Block Copolymer, More Particularly Styrene Block Copolymer

The elastomer component (block copolymer component) comprises at least one kind of a saturated vinylaromatic block copolymer, more particularly of a saturated styrene block copolymer. This saturation refers not to the vinylaromatic block, but to the elastomer block, i.e. soft block. In accordance with the invention, therefore, it is also possible to select mixtures of different saturated vinylaromatic block copolymers, especially saturated styrene block copolymers. The block copolymer typically has at least proportionally the structure of a linear triblock copolymer or linear or radial multiblock copolymer. More particularly the block copolymer is selected at least proportionally from the group consisting of polystyrene-poly(ethylene-co-butylene)-polystyrene, polystyrene-poly(ethylene-co-propylene)-polystyrene, polystyrene-poly(isoprene-co-butadiene)-polystyrene saturated in the elastomer block, polystyrene-polyisobutylene polystyrene, and a mixture thereof. In combination having linear triblock copolymer or with linear or radial multiblock copolymer, such as, in particular, with one or more of the aforesaid linear triblock copolymers, it is possible advantageously to use diblock copolymer. The diblock copolymer is preferably selected from the group consisting of polystyrene-poly(ethylene-co-butylene), polystyrene-poly(ethylene-co-propylene), polystyrene-poly(isoprene-co-butadiene) saturated in the elastomer block, polystyrene-poly-isobutylene and a mixture thereof. In general, SEBS refers to any polystyrene-poly(ethylene-co-butylene) block copolymer, SEPS to any polystyrene-poly(ethylene-co-propylene) block copolymer, SEEPS to any polystyrene-poly(isoprene-co-butadiene) block copolymer saturated in the elastomer block, and SiBS to any polystyrene-polyisobutylene block copolymer. In each case these may also be a block copolymer mixture with different structures, such as, for example, a mixture of linear triblock copolymer, diblock copolymer and optionally at least one further structure.

The proportion of the elastomer component, i.e. of the saturated vinylaromatic block copolymer, in the adhesive composition is 25 wt % to 50 wt %, more preferably 30 wt % to 40 wt %. With these weight proportions, an as-desired cohesion of the adhesive composition is ensured.

The elastomer component advantageously comprises, at least proportionally, a diblock copolymer consisting of an A block (polymer block formed primarily of vinylaromatic such as especially styrene) and a B block (polymer block formed primarily by polymerization of butadiene (and subsequent hydrogenation), isoprene (and subsequent hydrogenation) and/or isobutylene). Diblock copolymers contribute to tack and wet-out capacity of the adhesive composition. At least one vinylaromatic block copolymer such as styrene block copolymer is typically a triblock copolymer or a higher multiblock copolymer having at least two A blocks and at least one B block. As a triblock copolymer, this copolymer may have a linear A-B-A structure. Likewise employable are block copolymers of radial architecture, and also star-shaped and linear multiblock copolymers. Triblock and multiblock copolymers contribute to the cohesion. A plurality of different diblock copolymers can be used. A plurality of triblock and/or multiblock copolymers can be used. The overall block copolymer content of the adhesive composition is at least 25 wt % and at most 50 wt %. Significantly lower proportions of elastomer result in insufficient cohesion, which is manifested in reduced holding power, and/or to strongly pronounced oozing. Significantly higher proportions of elastomer lead to a drop in bond strength particularly on non-polar substrates. Another characteristic which suffers is the wet-out on porous and/or fibrous substrates.

The proportion of diblock copolymer relative to the elastomer component in the adhesive formulation is preferably up to at most 50 wt %, more preferably 10 wt % up to at most 30 wt %. Significantly higher proportions of diblock lead to insufficient cohesion, which is manifested in reduced holding power. Accordingly, the proportion of triblock or higher multiblock copolymer in the elastomer component is preferably from 50 wt % to 100 wt %, more preferably 70 wt % to 90 wt %, in relation to the elastomer component. Of the triblock or higher multiblock copolymers, the triblock copolymers are particularly preferred.

The weight-average molar mass of the block copolymers (determined by Test Ia) is between 50 000 g/mol and 500 000 g/mol, preferably between 75 000 g/mol and 200 000 g/mol. The proportion of vinylaromatic block, such as especially polystyrene block, in the block copolymers may be different from one kind of block copolymer to another in the formulation, but is typically at least 12 wt %, preferably at least 25 wt %, and at most 40 wt %, preferably at most 35 wt %. Too low a portion of vinylaromatic leads to insufficient physical crosslinking, which is created in the vinylaromatic block copolymers by microphase separation. The physical crosslinking is important for holding power and it counteracts oozing. In the case of too high a portion of vinylaromatic, conversely, the adhesive loses tackiness.

Polystyrene-polyisobutylene block copolymers are available under the “Sibstar” brand from Kaneka. SEBS and SEPS can be acquired under the name “Kraton G” from Kraton. SEPS and SEEPS are offered, for example, as “Septon” by Kuraray. SEBS is sold by Asahi as “Tuftec H” and by Dynasol as Calprene CH.

### (b) First Tackifier Resin

Tackifier resins are special compounds having a lower molar mass in comparison to the elastomers, customarily having a molecular weight (Test Ib) M_{w}<5 000 g/mol. Typically the molecular weight M_{w} is from 500 to 5 000 g/mol, preferably from 500 to 2 000 g/mol. The at least one first tackifier resin has a DACP (by Test II) of at least about +25° C. and also an MMAP (by Test III) of at least about +60° C. The tackifier resin has a resin softening temperature (by Test IV) of at least about 90° C., preferably of at least about 110° C., and at most +140° C., preferably of at most +130° C. The at least one first tackifier resin used is a hydrocarbon resin.

Excessive polarity (inadequate DACP) leads to incipient compatibility with the vinylaromatic blocks, with the possible consequence of a reduction in cohesion and hence of oozing.

Excessive aromaticity (inadequate MMAP) leads to incipient compatibility with the vinylaromatic blocks, with the possible consequence of a reduction in cohesion and hence of oozing.

Hydrogenated hydrocarbon tackifier resins are especially suitable tackifiers for the self-adhesive composition of the invention.

Those with preferential suitability include
hydrogenated polymers of dicyclopentadiene (for example Escorez 5300er series; Exxon Chemicals//Sukorez series from Kolon)
hydrogenated polymers of preferably C8 and C9 aromatics (for example Regalite and Regalrez series; Eastman Chemical//Arkon P series; Arakawa) which may be produced by hydrogenation of polymers from pure aromatics streams or else by hydrogenation of polymers based on mixtures of different aromatics
partially hydrogenated polymers of C8 and C9 aromatics (for example Regalite and Regalrez series; Eastman Chemical//Arkon M; Arakawa)
hydrogenated polyterpene resins (for example Clearon P; Yasuhara)
hydrogenated C5/C9 polymers (for example ECR-373; Exxon Chemicals)
aromatic-modified, selectively hydrogenated dicyclopentadiene derivatives (for example Escorez 5600er series; Exxon Chemicals)
hydrogenated C5 polymers (for example Eastotac series; Eastman Chemical)

Examples of particularly suitable first tackifier resins are the hydrogenated hydrocarbon resins sold under the Regalite R 1100 and R 1125 designations by Eastman Chemical.

The total proportion of first tackifier resin is 20 wt % to 50 wt %, preferably 25 wt % to 45 wt %.

### (c) Second Tackifier Resin

The at least one second tackifier resin has a DACP (by Test II) of at most about 0° C. and also an MMAP (by Test III) of at most about +30° C. The second tackifier resin has a resin softening temperature (by Test IV) of at least about 70° C., preferably of at least about 90° C., and at most+140° C., preferably of at most+120° C. The at least one second tackifier resin used is advantageously an oxygen-containing resin, very preferably esters of rosin, and especially stabilized and/or hydrogenated products.

Preferred among these resins are tackifier resins or tackifier resin mixtures selected from: (a) unhydrogenated, partially and/or fully hydrogenated rosin-based resins, (b) unhydrogenated, partially and/or fully hydrogenated rosin ester-based resins, (c) unhydrogenated, partially and/or fully hydrogenated crude tall oil-based resins, (d) unhydrogenated, partially and/or fully hydrogenated crude tall oil ester-based resins. The main constituent of the aforesaid rosins are resin acids comprising primarily pimaric acid and abietic acid. Other resin acids comprised, and/or synthetically modified resin acids, are neoabietic acid, palustric acid, dihydroabietic acid or dehydroabietic acid, isopimaric acid, laevopimaric acid, and boswellic acid. The tall oil is an oily composition obtained from the solid rosin and comprising the aforementioned resin acids and also fatty acids, especially unsaturated fatty acids having 18 carbons, and sterols. The resin acids and/or fatty acids may be esterified, particularly with triethylene glycol, glycerol or pentaerythritol, and/or oligomerized, and/or unmodified, stabilized, (partially, highly or fully) hydrogenated, dehydrogenated or disproportionated.

Examples of resins which can be used as the second tackifier resin are as follows:

Resins from Eastman Chemical based on glycerol esters of rosin and/or of tall oil, such as Permalyn™ 2085, Permalyn™ 5095, Permalyn™ 5095-C, hydrogenated or partially hydrogenated rosin such as Foral™ 105-E CG, Foral™ AX-E, Foral™ 85-E, Foral™, 85-E CG, Foral™ 105-E, Dymerex™, Foralyn™ E, Poly-Pale™, Staybelite™ Resin-E, resins based on pentaerytritol esters of rosin and/or tall oil, such as Permalyn™ 51 1-M, Permalyn™ 3100, Permalyn™ 51 10, Permalyn™ 51 10-C, Permalyn™ 61 10, Permalyn™ 61 10-M and Permalyn™ 8120;

Resins from Pinova such as Pinova™ Ester Gum 8DA, Melhi® NLM, Pexalyn® 9085, Staybelite® Ester 5, Staybelite® Ester 5A, Staybelite® Ester 10, Staybelite® Ester 10A, Foral® 85, Foral® 85LB, Foral® 2085, Pentalyn® A, Pexalyn® 9100, Pexalyn® T100, Pexalyn® 295, Pentalyn® H, Pentalyn® HA, Pentalyn® 830, Pentalyn® FC, Pentalyn® G, Pentalyn® X, Foral® 105;

Resins from DRT such as Granolite SG, Granolite P, Dertoline SG2, Dernatac G95, Dernatac P105, Hydrogral P.

The second tackifier resins are preferably rosins or crude tall oil resins; hydrogenated or disproportionated rosin esters are especially preferred. Mention may be made explicitly here of Foral 105-E, Foral 85-E and especially Foral AX-E (all products of Eastman Chemical).

The overall proportion of second tackifier resin is 0 wt % to 25 wt %, preferably 5 wt % to 20 wt %, very preferably 10 wt % to 15 wt %.

In particular, the proportion of second tackifier resin is 0 wt % to 10 wt % when the at least one plasticizer is used at 5 wt % to 25 wt %. Independently of this, the proportion of second tackifier resin is 5 wt % to 25 wt %, preferably 10 wt % to 20 wt %, when the at least one plasticizer is used at 5 wt % to 15 wt %.

### (d) Aliphatic or Cycloaliphatic Alkyl Esters as Plasticizers

For the purposes of this invention, plasticizers based on aliphatic or cycloaliphatic alkyl esters are used. The esters in question are preferably esters of aliphatic or cycloaliphatic carboxylic acids, more particularly dicarboxylic acid. It is also possible, though, to use phosphoric esters (phosphates). The aliphatic carboxylic acid esters include alkyl or cycloalkyl adipates such as especially di(2-ethylhexyl) adipate, diisononyl adipate, diisodecyl adipate, ditridecyl adipate and dioctyl adipate as examples. Further examples are alkyl and cycloalkyl sebacates such as especially di(2-ethylhexyl) sebacate and alkyl and cycloalkyl azelates such as especially di(2-ethylhexyl) azelate. Particular preference is given to using aliphatic or cycloaliphatic cyclohexyldicarboxylic diesters, as described for example in WO 2011/009672 A1, more particularly 1,2-diisobutylcyclohexanedicarboxylic esters, 1,2-di-(2-ethylhexyl)cyclohexanedicarboxylic esters or 1,2-diisononylcyclohexanedicarboxylic esters (also referred to as “DINCH”). Selected representatives of this group are available from BASF SE, for example.

In a first configuration of the present invention, the proportion by weight of the alkyl esters as plasticizers is 5 wt % to 25 wt %, in the case where the at least one second tackifier resin is used at up to 10 wt %. Too high a proportion by weight of the sum total of alkyl ester and second tackifier resin has adverse effects on the cohesion.

In a second configuration of the present invention, the proportion by weight of the alkyl esters as plasticizers is 5 wt % to 15 wt %, in the case where the at least one second tackifier resin is used at not less than 5 wt % and not more than 25 wt %, preferably at not less than 10 wt % and not more than 20 wt %. Too high a proportion by weight of the sum total of alkyl ester and second tackifier resin has adverse effects on the cohesion.

Customary low-viscosity plasticizers such as mineral oils are disadvantageous for the purposes of this invention. The proportion thereof in the overall formula is preferably at most 1 wt %, and very preferably no such plasticizers at all are present. Other plasticizers such as low molecular mass polybutenes or low molecular mass C5-based hydrocarbon plasticizer resins are unsuitable because of their possible adverse effects on the peel adhesion.

### (e) Optional Further Additives

Further additives which may be added to the adhesive composition include, in particular, protectants. These would include primary and secondary ageing inhibitors, light stabilizers and UV protectants, and flame retardants, and also fillers, dyes and pigments. The adhesive composition may accordingly be coloured as desired or white, grey or black.

Typical amounts of use for an additive are up to 2 wt %, based on the overall adhesive composition.

Fillers or pigments can be added at higher levels, typically in a proportion of up to 5 wt %, based on the overall adhesive composition.

Additives which can typically be utilized are as follows:
primary antioxidants such as, for example, sterically hindered phenols
secondary antioxidants, such as, for example, phosphites or thioethers
process stabilizers such as, for example, C radical scavengers
flame retardants
light stabilizers such as, for example, UV absorbers or sterically hindered amines
dyes and/or pigments (e.g. carbon black)
processing assistants
(nano)fillers such as, for example, silicon dioxide, aluminium oxide, titanium dioxide or phyllosilicates, and also colour pigments and dyes (for transparent but specifically coloured embodiments) and also optical brighteners
endblock reinforcer resins, and also
optionally further polymers of preferably elastomeric nature; elastomers utilizable accordingly include, among others, those based on pure hydrocarbons, for example chemically substantially saturated elastomers such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing, allyl- or vinyl ether-containing polyolefins.

Antioxidants are used more particularly in an amount of 0.2 wt % to 1.5 wt %. Particularly preferred in this context are ageing inhibitors selected from the group of the mono- and/or polynuclear phenols carrying a benzyl thioether moiety positioned ortho- and/or para to the phenolic OH group.

Further preferred is the addition of at least one UV protectant, more particularly in an amount of 0.5 wt % to 2 wt %.

The present invention also relates, furthermore, to adhesive tapes comprising at least one layer of an adhesive composition of the invention.

Typical product constructions are adhesive tapes (single-sided or double-sided), adhesive sheets, and adhesive diecuts. Single-sided or double-sided adhesive tapes, sheets or diecuts comprise at least one ply of a carrier which remains permanently in the product. Where no carrier layer present permanently in the adhesive tape is used (in the case of what is called an adhesive transfer tape), then the thicknesses of the layers of the adhesive composition are at least 20 μm and up to 1 mm. Very preferred are layer thicknesses of between about 40 μm and about 800 μm. Diverse possibilities for application are also conceivable for adhesive tapes between about 75 μm and about 400 μm, provided no further layers are employed, such as, in particular, carrier material present permanently in the adhesive tape. Where adhesive layers based on adhesive compositions of the invention are used on a carrier material which is present permanently in the adhesive tape, the thicknesses of these adhesive layers are at least 15 μm and preferably at most 250 μm, preferably at least 50 μm and very preferably at most 150 μm.

In the case of double-sided adhesive tapes having at least one carrier remaining permanently in the product, different adhesive compositions may be applied on the two sides of the carrier. By this means it is possible to join surfaces having very different properties to one another. Conceivable, for example, are double-sided adhesive tapes which comprise a carrier layer which remains permanently in the adhesive tape and a first main surface of which is assigned a layer A of an adhesive composition of the invention, and a second main surface of which is assigned a layer B of an alternatively selected layer of adhesive composition. For layer B it is possible advantageously to select a polyacrylate-based adhesive composition. For layer B, moreover, a polyisobutylene-based adhesive composition may advantageously be selected. For layer B, moreover, a polyethylene-vinyl acetate (EVA)-based adhesive composition may advantageously be selected. For layer B it is possible, moreover, advantageously to select an adhesive composition based on saturated vinylaromatic copolymers, such as, in particular, styrene block copolymers, which do not conform to the prescriptions for adhesive formulations of the invention—that is, for example, containing different types of tackifier and/or plasticizer resins, or tackifier and/or plasticizer resins in different proportions.

For layer B, however, it is also possible to select a further layer of an adhesive composition of the invention, in the same way or a different way in comparison to that selected for layer A.

The optionally at least one carrier film remaining permanently in the product may be produced in principle using any film-forming and/or extrudable polymers. In this regard see, for example, the compilation by Nentwig [J. Nentwig, Kunststofffolien, chapter 5, 2nd Edn., 2000, C. Hanser, Munich]. One preferred configuration uses polyolefins. Preferred polyolefins are prepared from ethylene, propylene, butylene and/or hexylene, it being possible in each case to polymerize the pure monomers, or mixtures of the stated monomers are copolymerized. Through the polymerization process and through the selection of the monomers it is possible to control the physical and mechanical properties of the polymer film, such as the softening temperature and/or the tensile strength, for example.

Another preferred configuration of this invention uses polyvinyl acetates in respect of carrier films remaining permanently in the product. Polyvinyl acetates may include as well as vinyl acetate also vinyl alcohol as a comonomer, in which case the free alcohol fraction may be varied within wide limits. A further preferred configuration of this invention uses polyester as carrier film. One particularly preferred configuration of this invention uses polyesters based on, for example, polyethylene terephthalate (PET) or polybutylene terephthalate (PBT). Also possible is to use halogenated hydrocarbons as film base material, such as, for example, polyvinylidene chloride or fluorinated systems. A further preferred configuration of this invention uses polyamides for producing films. The polyamides may consist of a dicarboxylic acid and a diamine or of two or more dicarboxylic acids and diamines. Besides dicarboxylic acids and diamines, carboxylic acids and amines with higher functionality can also be used, and can also be used in combination with the aforesaid dicarboxylic acids and diamines. The film is stiffened using preferably cyclic, aromatic or heteroaromatic starting monomers. Another configuration of this invention uses polymethacrylates to produce films. Here, the glass transition temperature of the film can be controlled through the choice of the monomers (methacrylates and also, in some cases, acrylates). Moreover, the polymethacrylates may also comprise additives, in order, for example, to increase the flexibility of the film or to raise or lower the glass transition temperature, or to minimize the formation of crystalline segments. A further preferred configuration of this invention uses polycarbonates for producing films. Furthermore, in another configuration of this invention, vinylaromatic- and vinylheteroaromatic-based polymers and copolymers may be used for producing the at least one optional carrier film. The optionally at least one carrier film may alternatively be monoaxially oriented, biaxially oriented or unoriented.

To produce a material in film form, it may be appropriate to add additives and further components which improve the film-forming properties, lessen the tendency towards formation of crystalline segments, and/or specifically improve or else, where appropriate, detract from the mechanical properties. Other optionally employable additives present may include ageing inhibitors, light stabilizers such as, in particular, UV protectants, antioxidants, further stabilizers, flame retardants, pigments, dyes and/or expandants.

The optionally at least one carrier film may itself be employed as a single-layer construction, or else as a multilayer composite obtained, for example, by coextrusion. Furthermore, the carrier film may also have been provided with a functional layer, and/or pretreated on one and/or both sides. Where both sides are pretreated and/or coated, the nature and/or extent of the pretreatment and/or coating may be identical or different. Such pretreatment and/or coating may serve, for example, for improved anchorage of a further layer, such as, for example, of the at least one layer A of adhesive composition, or of other, optionally employable layers. To this end it is particularly advantageous if one or both sides of the carrier film are pretreated with one or different kind(s) of primers and/or if one or both sides of the carrier film are treated by corona treatment and/or flaming and/or plasma treatment and/or other methods for surface activation.

For the purposes of this invention, the optionally at least one carrier film may be transparent and colourless or else transparent and coloured. Also in accordance with the invention is for the film not to be transparent and also to be white, grey, black or coloured.

The optionally at least one layer of a carrier material has a layer thickness of between 5 μm inclusive and 500 μm inclusive, preferably between 10 μm inclusive and 100 μm inclusive.

The adhesive composition of the present invention is suitable especially for porous and/or rough and/or fibrous surfaces. The substrate in this case may also be flexible. The substrate may also be non-polar. It may comprise, in particular, woven, laid-scrim and knitted fabrics, particularly nonwoven webs.

Examples of fibrous substrates are nonwoven webs, which are fabrics composed of individual fibres. Any of the nonwoven webs defined according to the DIN EN 29092 standard (1992/08) may be used here. The web consists of fibres loosely laid together which as yet are not joined to one another. The strength results from the adhesion inherent in the fibre. Differentiation is also made between consolidated and unconsolidated webs. The fibres are randomly distributed. The webs can be differentiated according to the fibre materials. Fibre materials which can be used are mineral fibres, such as glass, mineral wool or basalt, for example, animal fibres, such as silk or wool, for example, plant fibres, such as cotton, cellulose, for example, manmade fibres, such as polyamide, polypropylene, polyphenylene sulfide, polyacrylonitrile, polyimide, polytetrafluoroethylene, aramid or polyester, for example, or mixtures of the aforesaid substances. The fibres may be consolidated mechanically by needling or water jets, chemically by addition of binders, or thermally by softening in a suitable gas stream, between heated rolls, or else in a flow of steam.

One very preferred configuration of the invention uses cellulose-based nonwoven webs. Polyolefin-based webs are another preferred substrate. The basis weight of the webs is preferably between 4 and 100 g/m², more preferably between 10 and 70 g/m². Such webs are available commercially, for example, from Glatfelter. The thickness of these webs is preferably between 20 and 100 μm, most preferably between 30 and 60 μm.

If an article having a porous surface is to be affixed on an article having a smooth surface, then very good suitability is possessed by double-sided adhesive tapes whereof one side is coated with an adhesive composition in accordance with the present invention while the other side bears an applied adhesive composition which adheres well to smooth surfaces. One example of an application of this kind is the placement of protective covers on an object to be protected. The protective covering in this case consists of a fibrous and therefore porous laid scrim which may be polyolefin-based. An example of a protective cover material of this kind is Tyvek® spun bonded olefin from DuPont (http://www.dupont.de/produkte-und-dienstleistungen/verpackungsmaterialien-und-loesungen/industrielle-verpackungen/use-and-applications/protective-covers.html from Dec. 18, 2017).

The adhesive compositions of the invention permit a certain flow of the adhesive composition into the porous and/or fibrous substrate and at the same time ensure the requirements for weathering resistance. As well as effective adhesion to porous substrates, moreover, and in spite of the addition of plasticizers, the oozing of the adhesive composition is prevented.

Adhesive films may take on any desired extents in two dimensions. Adhesive tapes are for example 2 mm, 5 mm, 10 mm, 20 mm or 50 mm wide. Adhesive tapes may have been wound up into rolls.

The general expression “adhesive tape” in the sense of this invention encompasses all sheetlike structures such as two-dimensionally extended films or film sections, tapes with extended length and limited width, tape sections, dye-cuts, labels and the like.

Adhesive products are in particular provided on a release liner (preferably siliconized paper or siliconized film). The liner may be equipped for one-sided release. In that case, advantageously, a second ply of a liner is employed for masking off the second surface (particularly in the case of dye-cuts). The liner may also be equipped for double-sided release. In that case it is possible to operate with one liner ply (especially in the case of adhesive tapes).

The preparation of the adhesive compositions may be either solvent-based or solvent-free. Solvent-free production is preferred since it is cheaper and quicker; there may also be areas of application in which the solvent-based production is preferred. This is the case, for example, when particular requirements are imposed on the quality for the optical properties. Mention may be made in this connection of adhesive bonding applications in the area of consumer electronics devices.

Particularly preferred for solvent-free production is the use alternatively of a hotmelt compounder or of an extruder.

Further layers of the adhesive tape can be introduced into the construction of the product by lamination.

Accordingly, the invention also relates to a double-sided adhesive tape for affixing large sheetlike structures for the purposes of transit protection and/or assembly protection to substrates such as automotive paint, consisting of a first adhesive side A comprising an adhesive composition of the invention, and a second adhesive side B comprising an adhesive composition B, where adhesive composition B is self-adhesive and suitable for reversible bonding to automotive paint.

Alternatively, the invention relates to a double-sided adhesive tape for affixing large sheetlike structures for the purposes of transit protection and/or assembly protection to substrates such as automotive paint, consisting of a first adhesive side A comprising an adhesive composition of the invention, and a second adhesive side B comprising an adhesive composition B which comprises isobutyl rubber or derivatives or blends thereof.

In use the side of the adhesive tape with the adhesive composition of the invention faces the large sheetlike structure and is used for affixing it. EP 2 036 961 A1 describes applications of this kind.

Generally speaking, an article according to the invention consists of an adhesive tape having two adhesive layers. In one advantageous version these layers are supported by a carrier material. This material may be a woven, knitted, laid-scrim or nonwoven fabric, a film, paper and composites and combination products thereof, based on natural or synthetic materials or a combination or a mixture thereof.

Accordingly and advantageously, use is made of polymeric films, nonwovens or woven fabrics made from polypropylene, polyester, polyamide, polyurethane or polyethylene, both alone and in combination with mineral fibres such as glass fibres or carbon fibres, or from products such as woven, laid-scrim and knitted fabrics with cellulose or cotton fibres, and also of metallic origin. For specific applications it is also possible to use hybrid products such as compounded formulations or blended fibre products, optionally in the form of blended fibre filaments, yarns or twists. These may in some cases be coloured or otherwise equipped to give the carrier material optical or mechanical features and properties. In alternative versions it is also possible to use fibres of natural origin such as cotton, silk, flax or viscose staple.

In the case of alternative embodiment of the article of the invention, a nonwoven web is used as carrier material for the masking of surfaces. The web in this case is reinforced through the formation of stitches formed by loops from the fibres of the web, the number of stitches on the web being advantageously at least 3/cm, preferably 5/cm to 50/cm.

In another advantageous embodiment, the article of the invention can be torn by hand perpendicularly to the orientation and/or in the direction of the stitches. This is frequently employed when the product of the invention is wound up on itself to form a roll.

In the case of another embodiment, this tearability is unnecessary. Here, the products in question may be die-cut products for bonding to the large sheetlike structure.

The adhesive composition of the invention advantageously has the following profile of properties:

| | | Preferred | |
|---|---|---|---|
| | Performance | performance | Very preferred |
| Property | level | level | performance level |
| Peel adhesion (Test V) | ≥8 N/cm | ≥10 N/cm | ≥12 N/cm |
| Ageing resistance | OK | OK | OK |
| (Test VI) | | | |

### Test Methods

### Test Method I—Molecular Weight, GPC

Ia: Block copolymers: the average molecular weight M_{w} (weight average) of the block copolymers—also called molar mass—is determined by means of gel permeation chromatography (GPC). The eluent used is THF. The measurement is made at 23° C. The pre-column used is PSS-SDV, 5 μm, ID 8.0 mm×50 mm. Separation takes place using the columns PSS-SDV, 5 μm, 10³ Å, 10⁵ Å and 10⁶ Å each with ID 8.0 mm×300 mm. The sample concentration is around 3 g/l, the flow rate 1.0 ml per minute. Measurement is made against PS standards. The detector used is a refractive index detector.

Ib: Tackifier resins: the average molecular weight M_{w} (weight average) of the tackifier resins—also called molar mass—is determined by means of gel permeation chromatography (GPC). The eluent used is THF. The measurement is made at 23° C. The pre-column used is PSS-SDV, 10 μm, ID 8.0 mm×50 mm. Separation takes place using the columns PSS-SDV, 5 μm, 10³ Å and 10² Å each with ID 8.0 mm×300 mm. The sample concentration is around 2 g/l, the flow rate 1.0 ml per minute. Measurement is made against PS standards. The detector used is a refractive index detector.

GPC is also an appropriate measurement method for determining the diblock fraction, where manufacturer details for a block copolymer are not available. For the block copolymers which can be used for the purposes of this invention and are prepared by living anionic or cationic polymerization, the molar mass distributions are typically narrow enough to allow polymer modes, assignable to triblock copolymers on the one hand and diblock copolymers on the other, to appear with sufficient resolution from one another in the elugram. The diblock fraction can then be quantified as the integral of the corresponding molar mass signal, relative to the sum total of the integrals of the molar mass signals of the diblock mode and of the other block copolymer modes (triblock mode or mode of a higher block copolymer).

### Test Method II—DACP

The DACP is the diacetone cloud point and for the purposes of the present invention is determined as follows: 5.0 g of test substance (the tackifier resin specimen under investigation) are weighed out into a dry sample glass and admixed with 5.0 g of xylene (isomer mixture, CAS [1330-20-7], ≥98.5%, Sigma-Aldrich #320579 or comparable). The test substance is dissolved at 130° C. and then cooled to 80° C. Any xylene that has escaped is made up of further xylene, to restore 5.0 g of xylene. Then 5.0 g of diacetone alcohol (4-hydroxy-4-methyl-2-pentanone, CAS [123-42-2], 99%, Aldrich #H41544 or comparable are added). The sample glass is shaken until the test substance has completely dissolved. For this purpose, the solution is heated to 100° C. The sample glass containing the resin solution is then introduced into a Chemotronic Cool cloud point instrument from Novomatics, in which it is heated to 110° C. Cooling takes place at a cooling rate of 1.0 K/min. The cloud point is detected optically. A recording is made for this purpose of the temperature at which the clouding of the solution amounts to 70%. The result is reported in ° C. If no cloud point has been reached by −50° C., measurement is ended and “<−50° C.” is recorded as the result for the DACP. The lower the DACP, the higher the polarity of the test substance.

Regarding the determination of DACP, reference is also made to C. Donker, PSTC Annual Technical Seminar, Proceedings, pp. 149-164, May 2001.

### Test Method III—MMAP

MMAP is the mixed methylcyclohexane-aniline cloud point, determined using a modified ASTM D 611-12(2016) method. For the purposes of the present invention, the MMAP is determined by weighing out 5.0 g of test substance, i.e. the tackifier resin specimen under investigation, into a dry sample glass and admixing it with 10 mL of dry aniline (CAS [62-53-3], 99.5%, Sigma-Aldrich #51788 or comparable) and 5 ml of dry methylcyclohexane (CAS [108-87-2], 99%, Sigma-Aldrich #300306 or comparable). The sample glass is shaken until the test substance has completely dissolved. For this purpose, the solution is heated to 100° C. The sample glass containing the resin solution is then introduced into a Chemotronic Cool cloud point instrument from Novomatics, in which it is heated to 110° C. Cooling takes place at a cooling rate of 1.0 K/min. The cloud point is detected optically. A recording is made for this purpose of the temperature at which the clouding of the solution amounts to 70%. The result is reported in ° C. The lower the MMAP, the higher the aromaticity of the test substance.

Regarding the determination of MMAP, reference is also made to C. Donker, PSTC Annual Technical Seminar, Proceedings, pp. 149-164, May 2001.

### Test Method IV—Resin Softening Temperature

The tackifier resin softening temperature is conducted in accordance with the relevant methodology, which is known as Ring & Ball and is standardized according to ASTM E28-14.

The tackifier resin softening temperature of the resins is determined using an automatic Ring & Ball tester HRB 754 from Herzog. Resin specimens are first finely mortared. The resulting powder is introduced into a brass cylinder with a base aperture (internal diameter at the top part of the cylinder 20 mm; diameter of the base aperture in the cylinder 16 mm; height of the cylinder 6 mm) and melted on a hotplate. The amount introduced is selected such that the resin after melting fully fills the cylinder without protruding. The resulting sample body, complete with cylinder, is inserted into the sample mount of the HRB 754. Glycerol is used to fill the heating bath where the tackifier resin softening temperature is between 50° C. and 150° C. For lower tackifier resin softening temperatures, it is also possible to operate with a water bath. The test balls have a diameter of 9.5 mm and weigh 3.5 g. In line with the HRB 754 procedure, the ball is arranged above the sample body in the heating bath and is placed down on the sample body. 25 mm beneath the base of the cylinder is a collecting plate, with a light barrier 2 mm above it. During the measuring process, the temperature is increased by 5° C./min. Within the temperature range of the tackifier resin softening temperature, the ball begins to move through the base aperture of the cylinder, before finally coming to rest on the collecting plate. In this position it is detected by the light barrier, and at this point in time the temperature of the heating bath is recorded. A duplicate determination is conducted. The tackifier resin softening temperature is the average value from the two individual measurements.

### Test Method V—Bond Strength/Detachment Behaviour

To measure the bond strength on a fibrous substrate, first of all a test adhesive tape is produced. For this purpose, in line with the listed examples, a coated formulation is laminated manually using a rubber roller onto an etched polyethylene terephthalate film 23 μm thick. The open side of the adhesive layer is subsequently laminated with a ply of a spun bond web (assembly comprising 35 g/m² polyolefin copolymer film and 80 g/m² PP spun bond from CaPlast) by rolling over the laminated bond twice with a 2 kg steel roller. Sample strips 20 mm wide and about 300 mm long are cut from this assembly in such a way that the top and bottom carriers have a loose (adhesive-free) end on the same side of the test strip. Measurement is carried out using a tensile testing machine (e.g. from Zwick). The loose end of the lower carrier of the laminated bond (etched PET film) is fixed on the lower clamping jaw of the testing machine, while the loose end of the upper carrier (spun bond web) is clamped in the upper clamping jaw, and hence on the load cell. The pull-off velocity is 300 mm/min. The results are reported in N/cm and are averaged from three measurements. All of the measurements were conducted at room temperature under controlled atmospheric conditions. Variance in the web material may give rise to tolerances in the peel adhesion values of +/−2 N/cm. The desire is for a detachment operation in which there is fibre extraction from the web material (assessed as “fibre extraction”). Cohesive failure in the adhesive layer is an indicator of an adhesive formulation which is too elastic. Formulations exhibiting such detachment behaviour (assessed as “cohesive”) are accordingly not suitable for the present invention. If the peel adhesion values are too low, there is usually no fibre extraction. In that case the adhesive layer parts adhesively from the web material (assessed as “adhesive”), which is likewise not in accordance with the requirements. Test method V therefore on the one hand allows statements to be made concerning the performance capacity in relation to the bond strength of test specimens, and on the other hand allows statements to be made with respect to cohesion on the part of the adhesive formulations investigated that is in accordance with the requirements.

### Test Method VI—Ageing Resistance

The ageing resistance was ascertained by means of detachment tests of test adhesive tapes from paint surfaces after weathering tests. For this purpose, a Weatherometer test under Florida conditions was employed. Test adhesive tapes were produced as follows: From a solution in special-boiling-point spirit 60/95, a formulation consisting of 95 wt % Oppanol B80 and 5 wt % Sylvarez TP95 was coated onto a ply of release paper with graduated double-sided siliconization, and dried at 120° C. for 20 minutes to give an adhesive layer 15 g/m² thick. The open side of the adhesive layer was laminated with a blown polypropylene film 90 μm thick. On the side of the carrier opposite the polyisobutylene adhesives, a layer of an adhesive composition of the invention, located on a siliconized release paper, was laminated on manually using a rubber roller. Lastly, after the release paper had been removed, the open adhesive side of the formulation of the invention was laminated with a ply of spun bond web (see Test V) with the web side facing the adhesive layer, by manual rolling-on using a rubber roller. Finally, 20 mm test strips were cut in a length of around 300 mm; the second release paper was removed from the polyisobutylene-based adhesive layer; and by way of this layer the assembly was adhered, by being rolled over twice with a 2 kg steel roller, to a metal plate coated with paint (base coat: 20 μm waterborne black paint from BASF SE, dried at 70° C. for 4 min; clearcoat: 45 μm 2K paint FF99 from BASF SE, flashed at room temperature for 5 minutes and then dried at 140° C. for 20 minutes and aged for 24 hours before use).

The test assembly was subjected for 1000 h to an accelerated weathering test according to DIN EN ISO 4892-2:2013 in a Xenotest Beta LM Weather-o-Meter from Atlas B.V. (irrigation cycle 102:18; black standard temperature 65±2° C.; chamber temperature in the dry phase 40±5° C.; relative humidity in the dry phase 70±10%; intensity of irradiation 60 W/m² at 300-400 nm) and, after subsequent reconditioning at 23° C. and 50% relative humidity, an assessment was made of the detachment behaviour of the painted test plate. For this purpose, the specimen strips were peeled off manually from the test plate and the paint surface was inspected. Where residues of the adhesive tape specimen were found, or where the paint was recognizably deformed or its visual appearance otherwise altered, the assessment is “not OK”. If, on the other hand, no residues were found, or if the paint showed no discernible deformation or other alteration in its visual appearance, the assessment is “OK”.

### EXAMPLES

### Preparation of Specimens

The adhesive compositions were produced in a heatable double-sigma III-P1 hotmelt compounder from Aachener Maschinenbau Kupper. The jacket of the compounder was heated by means of a thermal oil heating bath from Lauda. The bath temperature set in this case was 190° C. Throughout the kneading operation, there was a protective gas atmosphere of CO₂. The compounder was operated at 50 rpm.

First of all the elastomers, together with the solid ageing inhibitor Irganox 1076 and also two UV protectants (a benzotriazole derivative and a HALS derivative), were weighed out and introduced into the compounder. Thereafter about 10% of the amount of solid resin was added (as far as possible according to the formula, resin I is chosen for this purpose) and kneading took place for 15 minutes. After that, at intervals of 10 minutes each, portions of one-third of the remaining quantity of tackifier resins, and also, lastly, plasticizer were added and incorporated.

After the end of the kneading operation, the kneading compounds were taken from the compounder and allowed to cool to room temperature.

The cooled compositions were positioned between two plies of siliconized release paper and pressed with a RLKV 25 hot press from Lauffer GmbH & CO KG at 130° C. to form hand specimens with the respective layer thickness. The adhesive layers were laminated onto a carrier material. This was done manually using a rubber roller. The carrier material employed was a cast polypropylene film 90 μm thick.

### Base Materials Used

TABLE 1
base materials used

| | Name | Type | Manufacturer |
|---|---|---|---|
| Elastomer | Kraton G1657 *) | Polystyrene-poly(ethylene-co- | Kraton Polymers |
| | | butylene) block copolymer, SEBS | |
| | | (polystyrene fraction 13 wt %; | |
| | | diblock fraction 29 wt %) | |
| Tackifier resin I | Regalite R1125 | Hydrocarbon resin (MMAP 83° C.; | Eastman Chemical |
| | | DACP 55° C., TRB 123° C.) | |
| Tackifier resin II | Foral AX-E | Rosin ester (MMAP −21° C.; | Eastman Chemical |
| | | DACP <−50° C., TRB 75° C.) | |
| | Foral 105-E | Rosin ester (MMAP 16° C.; | Eastman Chemical |
| | | DACP <−50° C., TRB 101° C.) | |
| | Foral 85-E | Rosin ester (MMAP 7° C.; | Eastman Chemical |
| | | DACP <−50° C., TRB 80° C.) | |
| Plasticizers | Hexamoll Dinch | Cyclohexyldicarboxylic diester | BASF SE |
| | Wingtack 10 | C5 plasticizer resin | Cray Valley |
| | Indopol H100 | Polybutene | Ineos Europe |
| | Abitol E | Hydroabietyl alcohol | Eastman Chemical |
| | Dercolyte LTG | Polyterpene plasticizer resin | DRT |
| Ageing inhibitor | Irganox 1076 | Sterically hindered phenol | BASF SE |
| UV protectants | A | Benzotriazole derivative | |
| | B | HALS derivative | |

*) cf. product information for Kraton “Product Guide Innovation Powered by Kraton Polymers” from 2016.

### Examples

All figures in wt %; all of the adhesive compositions (100 parts) also contained an additional 0.5 part each of a benzotriazole derivative, of a HALS derivative and of Irganox 1076.

TABLE 2

| | Example | Example | Example | Example | Example | Example |
|---|---|---|---|---|---|---|
| Base materials | I1 | I2 | I3 | I4 | I5 | I6 |
| Elastomer | | | | | | |
| Kraton 1657 | 38.0 | 35.0 | 40.0 | 30.0 | 35.0 | 30.0 |
| Tackifier resin I | | | | | | |
| Regalite R1125 | 42.0 | 40.0 | 20.0 | 40.0 | 40.0 | 36.0 |
| Tackifier resin II | | | | | | |
| Foral AX-E | | 5.0 | 25.0 | 15.0 | 12.5 | 20.0 |
| Plasticizer | | | | | | |
| Hexamoll Dinch | 20.0 | 20.0 | 15.0 | 15.0 | 12.5 | 14.0 |
| Layer thickness [μm] | 160 | 160 | 160 | 160 | 120 | 160 |
| Bond strength | 8.0 | 12.5 | 12.6 | 13.2 | 8.7 | 13.0 |
| (Test V) [N/cm] | | | | | | |
| Detachment | Fibre | Fibre | Fibre | Fibre | Fibre | Fibre |
| behaviour (Test V) | extraction | extraction | extraction | extraction | extraction | extraction |
| Ageing | OK | OK | OK | OK | OK | OK |
| resistance (Test VI) | | | | | | |

TABLE 3

| Base | Example | Example | Example | Example | Example |
|---|---|---|---|---|---|
| materials | C1 | C2 | C3 | C4 | C5 |
| Elastomer | 38.0 | 38.0 | 38.0 | 38.0 | 38.0 |
| Kraton 1657 | | | | | |
| Tackifier | 42.0 | 42.0 | 42.0 | 42.0 | 42.0 |
| resin I | | | | | |
| Regalite | | | | | |
| R1125 | | | | | |
| Tackifier | 20.0 | | | | |
| resin II | | | | | |
| Foral AX-E | | | | | |
| Plasticizers | | 20.0 | 20.0 | 20.0 | 20.0 |
| Wingtack 10 | | | | | |
| Indopol | | | | | |
| H100 | | | | | |
| Abitol-E | | | | | |
| Dercolyte | | | | | |
| LTG | | | | | |
| Layer | 160 | 160 | 160 | 160 | 120 |
| thickness | | | | | |
| [μm] | | | | | |
| Bond | 4.4 | 0.8 | 1.6 | 1.2 | 1.0 |
| strength | | | | | |
| (Test V) | | | | | |
| [N/cm] | | | | | |
| Detachment | Adhesive | Adhesive | Adhesive | Adhesive | Adhesive |
| behaviour | | | | | |
| (Test V) | | | | | |
| Ageing | Not | Not | Not | Not | Not |
| resistance | carried | carried | carried | carried | carried |
| (Test VI) | out | out | out | out | out |

TABLE 4

| | Example | Example | Example | Example | Example | Example |
|---|---|---|---|---|---|---|
| Base materials | I7 | I8 | I9 | I10 | C6 | C7 |
| Elastomer | | | | | | |
| Kraton 1657 | 30.0 | 30.0 | 30.0 | 30.0 | 30.0 | 30.0 |
| Tackifier resin I | | | | | | |
| Regalite R1125 | 40.0 | 40.0 | 40.0 | 30.0 | 35.0 | 39.0 |
| Tackifier resin II | | | | | | |
| Foral AX-E | 15.0 | | | 25.0 | 15.0 | 13.0 |
| Foral 105-E | | 15.0 | | | | |
| Foral 85-E | | | 15.0 | | | |
| Plasticizer | | | | | | |
| Hexamoll Dinch | 15.0 | 15.0 | 15.0 | 15.0 | 20.0 | 18.0 |
| Layer thickness [μm] | 120 | 120 | 120 | 160 | 160 | 160 |
| Bond strength | 11.9 | 9.2 | 14.1 | 9.0 | 3.6 | 7.7 |
| (Test V) [N/cm] | | | | | | |
| Detachment | Fibre | Fibre | Fibre | Fibre | Cohesive | Cohesive |
| behaviour (Test V) | extraction | extraction | extraction | extraction | | |
| Ageing | OK | OK | OK | OK | Not | Not |
| resistance (Test VI) | | | | | carried out | carried out |

Table 2 shows various adhesive compositions of the invention along with their properties in respect of bond strength, detachment behaviour and ageing resistance. The proportions of elastomer, tackifier resin I and optionally II, and plasticizer are varied within the ranges according to the invention. The adhesive compositions of the invention have a bond strength of at least 8.0 N/cm, and during the detachment operation there is the (desired) fibre extraction from the web material. Furthermore, all of the adhesive compositions of the invention passed the ageing resistance test to complete satisfaction.

In the case of the comparative examples which are reproduced in Table 3, either no plasticizer (Example C1) or no plasticizer in accordance with the invention (Examples C2 to C5) is used. Besides only low bond strengths, the adhesive compositions part adhesively from the web material, meaning that anchorage on the web material is inadequate, and adhesive composition and web material become separated from one another in the course of the detachment operation.

Table 4 embraces inventive examples 17 to 110 and also non-inventive, comparative examples C6 and C7. The latter contain a quantity of plasticizer that is too great for the proportion of tackifier resin II. The consequence is an excessively elastic adhesive composition which exhibits cohesive detachment of the adhesive composition; i.e., the anchorage on the web is indeed present, but there is detachment within the adhesive layer at low bond strengths of below 8 N/cm.

After corresponding testing for the ageing resistance, all of the adhesive compositions of the invention show a visually appealing appearance without deformations or other impairments.

With the present invention, accordingly, success has been achieved in providing adhesive compositions which are suitable for bonding on porous and/or fibrous materials and at the same time have a high long-term stability.

1. Adhesive composition comprising:
(a) about 25 wt % to about 50 wt % of at least one kind of a saturated vinylaromatic block copolymer,
(b) about 20 wt % to about 50 wt % of at least one kind of a first tackifier resin, which is a hydrocarbon resin, having a DACP of more than +25° C. and an MMAP of more than +60° C.,
and also either
(c1) 0 wt % to about 10 wt % of at least one kind of a second tackifier resin, having a DACP of less than 0° C. and an MMAP of less than +30° C., and
(d1) about 5 wt % to about 25 wt % of at least one kind of an aliphatic or cycloaliphatic alkyl ester as a plasticizer,
or
(c2) about 5 wt % to about 25 wt % of at least one kind of a second tackifier resin, having a DACP of less than 0° C. and an MMAP of less than +30° C., and
(d2) about 5 wt % to about 15 wt % of at least one kind of an aliphatic or cycloaliphatic alkyl ester as a plasticizer.

2. Adhesive composition according to claim 1, wherein the vinylaromatic block copolymer is a styrene block copolymer.

3. Adhesive composition according to claim 1, wherein the second tackifier resin is a rosin, a crude tall oil resin, a hydrogenated resin ester or a disproportionated rosin ester.

4. Adhesive composition according to claim 1, wherein the plasticizer is at least one plasticizer selected from the group consisting of esters of aliphatic or cycloaliphatic carboxylic acids, esters of dicarboxylic acids, and phosphoric esters.

5. Adhesive composition according to claim 4, wherein the plasticizer is at least one plasticizer selected from the group consisting of alkyl or cycloalkyl adipates, di(2-ethylhexyl) adipate, diisononyl adipate, diisodecyl adipate, ditridecyl adipate and dioctyl adipate, alkyl or cycloalkyl sebacates, di(2-ethylhexyl) sebacate, and alkyl or cycloalkyl azelates, di(2-ethylhexyl) azelate, aliphatic or cycloaliphatic cyclohexyldicarboxylic diesters, 1,2-diisobutylcyclohexanedicarboxylic esters, 1,2-di-(2-ethylhexyl)cyclohexanedicarboxylic esters or 1,2-diisononylcyclohexanedicarboxylic esters.

6. Adhesive composition according to claim 5, wherein the plasticizer is an aliphatic or cycloaliphatic cyclohexyldicarboxylic diester, a 1,2-diisobutylcyclohexanedicarboxylic ester, a 1,2-di-(2-ethylhexyl)cyclohexane dicarboxylic ester or a 1,2-diisononylcyclohexanedicarboxylic ester.

7. Adhesive composition according to claim 1, further comprising at least one UV protectant.

8. Adhesive composition according to claim 1, further comprising at least one antioxidant or an ageing inhibitor selected from the group of the mono- and/or polynuclear phenols carrying a benzyl thioether moiety positioned ortho and/or para to the phenolic OH group.

9. Adhesive composition according to claim 2, wherein the vinylaromatic block copolymer is an at least one saturated styrene block copolymer taking the form of a diblock copolymer with a proportion in relation to the elastomer components of up to about 50 wt %.

10. Adhesive tape comprising at least one adhesive composition according to claim 1.

11. Adhesive tape according to claim 10, further comprising a carrier.

12. Adhesive tape according to claim 10, wherein the adhesive tape is a transfer tape.

13. Method of using adhesive tape according to claim 10 for bonding on a porous and/or rough substrate.

14. Adhesive composition according to claim 1, wherein the at least one kind of the saturated vinylaromatic block copolymer is present at about 30 wt % to about 40 wt %.

15. Adhesive composition according to claim 1, wherein the at least one kind of the first tackifier resin is present at about 25 wt % to about 45 wt %.

16. Adhesive composition according to claim 1, wherein the at least one kind of the second tackifier resin is present at about 10 wt % to about 20 wt %.

17. Adhesive composition according to claim 2, wherein the styrene block copolymer comprises a polystyrene-poly(ethylene-co-butylene) block copolymer (SEBS), a polystyrene-poly(ethylene-co-propylene) block copolymer (SEPS), a polystyrene-poly(isoprene-co-butadiene) block copolymer saturated in an elastomer block (SEEPS), a polystyrene-polyisobutylene block copolymer (SiBS), or a mixture thereof.

18. Adhesive composition according to claim 7, wherein the at least one UV protectant is present in an amount of about 0.5 wt % to about 2 wt %.

19. Adhesive composition according to claim 8, wherein the at least one antioxidant is present in an amount of about 0.2 wt % to about 1.5 wt %.

20. Adhesive composition according to claim 9, wherein the diblock copolymer is present with a proportion in relation to the elastomer components of about 10 wt % to about 30 wt %.
